(19) United States
(12) Patent Application Publication
(10) Pub. No.: US 2004/0151664 A1
(43) Pub. Date: Aug. 5, 2004

(54) Method for the generation of energy

(76) Inventor: Norbert Auner, Frankfurt am Main (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/476,910

(22) PCT Filed: Apr. 26, 2002
(86) PCT No.: PCT/DE02/01531

(30) Foreign Application Priority Data
May 3, 2001 (DE) 10121477.4
Jul. 2, 2001 (DE) 10131505.8
Jan. 18, 2002 (DE) 10201773.5

(51) Int. Cl. C01B 3/06

(52) U.S. Cl. 423/658.2; 423/349

(57) ABSTRACT

A method for the generation of energy is described according to which Si is obtained from SiO₂ and/or silicates and the obtained Si is reacted with water to obtain SiO₂ with release of energy and hydrogen.

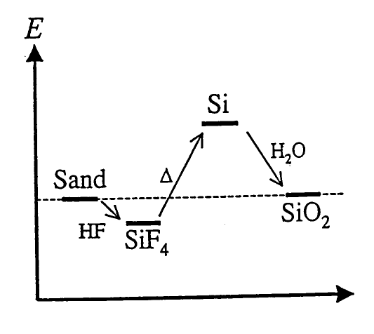

The present invention is directed to a method for the generation of energy.

It is known that the portion of the silicon (Si) of the composition of the earth crust is about 25.8% so that following oxygen Si is the most spread element on the earth. Si is the most important element of the mineral field wherein this element is present in the nature nearly exclusively in inorganic minerals, as for instance clay, sand and stones, and only in trace amounts in organisms of plants or animals. In the field of minerals Si is especially present as silicon dioxide (SiO₂) or as the corresponding silicates.

It is the object of the present invention to provide a method for the generation of energy according to which one can rely upon the large silicon resources on the earth and silicon is used as energy carrier.

According to the invention this object is achieved by a method for the generation of energy comprising the following steps:

Obtaining Si from SiO₂ and/or silicates and reacting the obtained Si with water to obtain SiO₂ with the release of energy and hydrogen.

Accordingly, with the inventive method in a first step elementary silicon is prepared from silicon dioxide (SiO₂) present in large amounts on the earth or from the corresponding silicates including fluorosilicates. This does not exclude that for the inventive method Si can be prepared from artificially made SiO₂ or corresponding silicates either, however, the particular advantages of the inventive method (great availability of the starting materials) result from the method variant indicated at first. Then, in a second step the obtained silicon is reacted with water to obtain silicon dioxide wherein energy is released and hydrogen is generated. For example, the generated energy can be used directly as propulsion energy (operation of a turbine etc.) or can be stored as heat energy. So, in an especially preferred embodiment of the inventive method the reaction of the silicon takes place in a turbine chamber so that here directly heat energy is converted into kinetic energy. Customary reaction chambers with discharge of the thermal energy can be used either.

The SiO₂ generated with the inventive method which is prepared in a high purity can be used for corresponding ranges of application (filling materials, adsorbents, trickling aids etc.) or can be recirculated in order to obtain herefrom silicon again.

Furthermore, according to the inventive method hydrogen is generated which is present as further energy source. In addition to the energy generation through the reaction of Si with hydrogen to obtain SiO₂ energy is generated by the combustion of the generated hydrogen. Hydrogen is an important energy carrier of the future (fuel cell etc.). Compared with carbon it results that silicon has approximately the same energy content and approximately the same energy density (determined from the heat of formation of the oxides). However, silicon as energy carrier has the great advantage that with its reaction no substances which are detrimental for the environment (CO₂, CO, hydrocarbons) are generated.

Preferably, the Si is prepared from sand, especially desert sand. As results have shown, no SiO₂ with high purity is required for the inventive method but one can rely upon sand, especially desert sand, which, as analyses have shown, has approximately a SiO₂ content of 80-85%. Sand, especially desert sand, is present in large amounts and can thus be used directly for the inventive method for the generation of energy without preceding processing.

Furthermore, the inventive method operates with nearly all SiO₂ sources, so for instance with sea sand, diatom earth, incinerated rice plants, glass residues, glass powder, silicates etc. either.

The first step of the inventive method, namely the preparation of Si from SiO₂, is carried out substantially in the following manner:

1. Reaction of SiO₂ and/or silicates including fluorosilicates with hydrofluoric acid to obtain SiF₄ and herefrom preparation of Si or mixing SiO₂ and/or silicates with metal fluoride and addition of sulphuric acid so that HF is released in situ and reacts with SiO2 and/or silicates to give SiF₄ wherefrom Si is prepared;

2. reduction of SiO₂ and/or silicates with metals, preferably Al or Mg, or metal hydrides or carbon to give Si; and

3. electrolytic conversion of SiO₂ and/or silicates and preparation of Si.

Of course, the invention does not exclude that further methods for the preparation of Si from SiO₂ can be used either.

Preferably, SiO₂ and/or silicates including fluorosilicates are directly or indirectly reacted with hydrofluoric acid to give SiF₄, as indicated under point 1. According to this method all SiO₂ sources can be used wherein the impurities do not raise any problems since a “self-cleaining” by the SiF₄ condensation takes place. Preferably, Si can be reacted to give Si thermolytically, catalytically or through metal reduction from the prepared SiF₄. A thermolysis is carried out between about 1500 and 2000° C. With the catalytical procedure preferably transition metal catylysts are used, preferably manganese complexes and nickel complexes of the oxidation stage IV.

Of course, further methods for the preparation of Si from SiF₄ can be used.

As regards the above-cited second variant, namely the reduction of the SiO₂ and/or of the silicates with carbon, one can work with biomass or similar ecologically conserving products in order to avoid great environmental loads.

The main step of the inventive method, namely the reaction of the Si with water to obtain SiO2, is preferably carried out by spraying process water onto finely distributed Si powder in a reaction chamber (turbine chamber etc.). Preferably, sea water can be used as process water which is present in large amounts. As already mentioned, the released hydrogen can be burned to obtain water for further energy generation or can be used as efficient hydrogen carrier by reaction to obtain ammonia. Accordingly, the method is characterized by the further advantage that water or fertilizers can be prepared in this manner which, just for desert countries, represents an especially great additional advantage.

For example, the above-cited preparation of Si from SiF₄ can be also carried out in such a manner that dry SiF₄ (silicontetrafluoride) is decomposed by means of a Pt wire brought in a glowing condition in an electrically manner and Si is prepared herefrom.

Another variant of the Si preparation from SiO₂ or silicates consists in the mixing of SiO₂ or silicates with coal and reaction of the same with SiCl₄ or SiF₄ at an increased temperature. When the temperature is increased a decompostion in Si+SiX₄ (X=Cl or F) results.

According to still another variant a mixture of fluorosilicates or SiF₄ with Na or potassium is heated to a temperature of 50-500° C. in an O₂ free atmosphere or in vacuum. If sodium is used, one operates preferably between 250 and 650° C., if potassium is used between room temperature and 100° C. In this manner Si is prepared either. Another possibility for the preparation of SiF₄ consists of the reaction of CaF₂, SiO₂ and H₂SO₄.

On the whole, one can state that energy is required with the inventive method for the preparation of Si from SiO2 (sand). However, with the following reaction of Si to give SiO2 energy is released which can be utilized. Furthermore, hydrogen is generated through the combustion of which further energy is obtained. Accordingly, silicon is used as energy carrier wherein the conversion of the same can be carried out in an environmentally conversing manner with the use of resources which are present in large amounts.

An energy of 911 kJoule/mol is generated with the inventive method including the combustion of hydrogen.

The water which is used for the reaction can be external water, for instance sea water, or process water (from original reactions for the generation of SiF₄ obtained water).

The hydrogen generated with the inventive method can be also reacted with released fluorine to obtain HF which can be recirculated. Furthermore, it can be conventionally used with nitrogen for the preparation of ammonia.

The enclosed figure shows diametrically the different energy levels with the inventive method.

As regards the reduction of SiF₄ by metals or metal hydride, preferably alkaline metals and alkaline earth metals and their hydrides are used, for example Ca, CaH₂, K, Na, NaH, but also Mg, Al. Especially preferred are Na, K, Ca, CaH₂ wherein in case of a reaction with CaH₂ the following equation is true:

2CaH₂+SiF₄→Si+2CaF₂+2H₂.

By that, molecular hydrogen is generated, too.

CaF₂ can be electrolytically converted to calcium and fluorine, but also with H₂SO₄ to obtain HF+CaSO₄. Thereafter, Ca can be again used for the SiF₄ reduction or HF for the SiF₄ preparation from SiO₂.

2Ca+SiF₄→2CaF₂+Si or

Ca+H₂→CaH₂.

Preferably, the reduction takes place at higher temperature (600-1000° C.).

When transfering SiF₄ with metal hydrides into SiH₄ preferably CaH₂ is used:

SiF₄+2CaH₂(250° C.)→SiH₄+2CaF₂.

Preferably, the obtained monosilane (SiH₄) is pyrolized at temperatures between 700 and 1000° C.:

SiH₄Si+2H₂.

When converting SiF₄ into difluorosilane (H₂SiF₂) a decomposition in a temperature range of 200-500° C., with a noble metal catalysis (Pt, Pd) already at room temperature, into Si, SiF₄ and H₂ takes place.

2H₂SiF₂→Si+SiF₄+2H₂.

The preparation of F₂SiF₂ is done in the following manner:

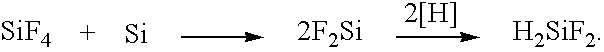

F₂Si reacts with hydrogen atoms (from hydrogen H₂, at the Pd or Pt catalyst) to obtain H₂SiF₂.

From F₂Si one can also prepare trifluorosilane with hydrofluoric acid according to the equation

F₂Si+HF→F₃SiH.

Then, trifluorosilane can be pyrolytically reacted with hydrogen at 1000-1400° C. to obtain Si+3HF.

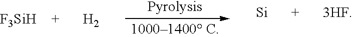

1. A method for the generation of energy comprising the following steps: obtaining Si from SiO₂ and/or silicates and reacting the obtained Si with water to give SiO₂ with release of energy and hydrogen.

2. The method according to claim 1, characterized in that the reaction of the Si takes place in a turbine chamber.

3. The method according to claim 1 or 2, characterized in that Si is obtained from sand, especially desert sand.

4. The method according to one of the preceding claims, characterized in that SiO₂ and/or silicates are reacted with hydrofluoric acid to give SiF₄ and that Si is obtained from SiF₄.

5. The method according to one of the claims 1 to 3, characterized in that Sio₂ and/or silicates are mixed with metal fluoride and sulphuric acid is added so that HF is released in situ and reacts with SiO₂ and/or silicates to give SiF₄ wherefrom Si is obtained.

6. The method according to claim 4 or 5, characterized in that SiF₄ is thermolytically reacted to give Si.

7. The method according to claim 4 or 5, characterized in that SiF₄ is catalytically reacted to give Si.

8. The method according to claim 4 or 5, characterized in that SiF₄ is reduced through metals or metal hydrides.

9. The method according to claim 4 or 5, characterized in that SiF₄ is reacted with metal hydrides to obtain SiH₄ wherefrom Si is pyrolytically obtained.

10. The method according to claim 4 or 5, characterized in that SiF₄ is converted into difluorosilane (H₂SiF₂) which decomposes into Si, SiF₄ and H₂.

11. The method according to the claims 1 to 3, characterized in that SiO₂ and/or silicates are reduced with carbon to obtain Si.

12. The method according to one of the claims 1 to 3, characterized in that Si is electrolytically obtained from SiO₂ and/or silicates.

13. The method according to one of the preceding claims, characterized in that process water is sprayed onto finely distributed Si powder.

14. The method according to one of the preceding claims, characterized in that sea water is used.

15. The method according to one of the preceding claims, characterized in that the released hydrogen is burned to obtain water for further generation of energy.
